(19) United States
(12) Patent Application Publication
(10) Pub. No.: US 2011/0000136 A1
(43) Pub. Date: Jan. 6, 2011

(54) ARTICULATION MEANS

(76) Inventor: Giancarlo Brun, Thiene (IT)

Correspondence Address: BIRCH STEWART KOLASCH & BIRCH, PO BOX 747, FALLS CHURCH, VA, 22040-0747, US

(21) Appl. No.: 12/918,778

(22) PCT Filed: Mar. 17, 2009
(86) PCT No.: PCT/IB09/00558

§ 371 Date: Aug. 20, 2010

(30) Foreign Application Priority Data
Mar. 21, 2008 (IT) VI2008A000070

(51) Int. Cl. E05F 11/54; E05D 3/06; E05D 3/12

(52) U.S. Cl. 49/358; 16/366

(57) ABSTRACT

The present invention concerns articulation means (1, 100, 200, 300, 400, 500, 600, 700, 800, 900, 901, 902, 903, 904, 905, 906, 907, 908, 909, 910, 911, 912, 913) suited to connect two elements (W, D), said means comprising a first part (2) and a second part (3), each one suited to be fixed to one of the above mentioned elements (W, D) and one first rotation axis (4) and a second rotation axis (5), preferably parallel to each other. Said articulation means also comprise kinematic means (6) suited to ensure that a rotation of the first part (2) by a first angle (A1) in relation to said first axis (4) determines a movement of the first axis (4) in relation to the second axis (5).

The invention concerns a hinge for doors.

More particularly, the invention concerns a hinge for the entrance door of campers, roulottes, autocaravans, motorhomes, buses and the back door of lorries, transport vehicles, industrial vehicles and the like.

As is known, it is important that the entrance door of recreational vehicles, like for example campers and autocaravans, is positioned against the external side wall of said vehicles when it is completely open.

This serves to prevent said door, when it is in this position, from representing a hindrance parallel to the side of the vehicle comprising the door itself.

In order to meet the requirement described above, said door is mounted on hinges that allow it to be opened completely until describing a 180° angle, more precisely from a first position in which it is closed to a second position in which it is open and arranged besides the lateral wall of the vehicle.

A first drawback posed by these hinges of known type lies in that they must be oversized in order to be able to bear the considerable weight of a door like those generally used in the sector of recreational vehicles.

Another drawback connected to the previous one is represented by the fact that said hinges are rather bulky, are heavy and difficult to install.

In particular, they are applied outside the surfaces of the body and of the door and therefore constitute undesired protrusions from the structure of the vehicle.

A further drawback associated with the previous one lies in that the projecting parts of these hinges are frequently subject to deformation and may get caught in other vehicles in case of accident.

Another drawback is constituted by the fact that the above mentioned hinges are directly exposed to the action of weather agents and to tampering by thieves, and furthermore they are unpleasant to look at.

Another drawback is represented by the fact that these hinges make it difficult to insert and/or replace one or more sealing gaskets without interruption between the door and the vehicle frame along their perimetral edge.

A further drawback lies in that they represent a hindrance for the application of profiles suited to cover entirely and without interruption the perimetral separation line between the door and the frame of the vehicle.

A further drawback posed by the hinges mentioned above is constituted by the fact that their production requires many operations like extrusion, bending, shaping, welding, milling, forging and the like.

Other known embodiments of hinges for recreational vehicles are the so-called hidden hinges that are built in the wall of the vehicle and within the thickness of the door.

A drawback posed by these last solutions is represented by the fact that they require complicated and expensive operations for the preparation of the apposite seats and recesses suited to house said hinges.

The object of the present invention is to overcome all the drawbacks described above.

In particular, it is one object of the present invention to produce articulation means and more particularly a hinge for doors especially suited to be installed on campers, roulottes, autocaravans, motorhomes, buses, lorries, transport vehicles, industrial vehicles and the like.

It is another object of the invention to propose a hinge that makes it possible to open completely, until reaching approximately 180°, the door mounted on one or more hinges of this type.

It is a further object of the invention to produce a hinge that makes it possible to close the entrance door of recreational vehicles like campers, roulottes, autocaravans and the like so that on the outside this door extends in such a way as to become coplanar with the wall with which it is coupled.

It is another object of the invention to propose a hinge that makes it possible to open completely, until reaching approximately 270°, the door mounted on one or more hinges of this type, for example the back doors of a transport vehicle.

It is another object of the invention to produce a compact hinge, with minimal dimensions, and which, when the door is closed, does not present protrusions and is not visible, both on the outside and on the inside.

It is a further object of the invention to produce a hinge, the installation of which requires neither the preparation of seats, recesses or other similar solutions within the thickness of the wall of the vehicle and of the door in order to house the hinge itself, nor other complicated and expensive operations.

It is another object of the invention to produce a hinge that guarantees safe operation for particularly long periods.

It is another and not less important object of the invention to produce a hinge that is simple to install, light, resistant, economic, easy to construct and to assemble, and also suitable for mass production.

The objects described above are achieved by the articulation means carried out as described and characterized in the corresponding independent claims.

Advantageous embodiments of the invention are described in the dependent claims.

The proposed solution advantageously makes it possible to produce a hinge that, once applied to the parts to be coupled, does not affect the appearance of the vehicle and does not run the risk of getting caught in other vehicles in case of accident.

Still advantageously, the proposed solution makes it possible to produce a hinge whose installation does not cause any hindrance, or in the worst case causes minimal hindrances for the installation and replacement of one or more sealing gaskets without interruption between the door and the frame of the vehicle, along their perimetral edge, said gaskets having the function of ensuring maximum protection against the infiltration of water and humidity.

Still advantageously, the proposed solution makes it possible to produce a hinge that allows the installation of covering profiles suited to cover and close completely the perimetral separation line between the door and the frame of the vehicle.

Still advantageously, the proposed solution makes it possible to produce a hinge that is not exposed to weather agents and makes the door on which it is installed more resistant to tampering.

Still advantageously, the proposed solution makes it possible to create a hinge comprising elements obtained by extrusion and/or die moulded and/or shaped starting from metallic or plastic materials and more generally natural or synthetic materials.

Again advantageously, the proposed solution makes it possible to produce a hinge eliminating some operations like bending, welding, forging, milling and similar operations that are typical of traditional processing methods, drastically reducing the hinge production time and limiting the use of labour to a minimum.

Still advantageously, the proposed solution allows a hinge to be produced that is suited to be used also in the naval and aeronautical sector, for example to assemble the doors of ships or airplanes, as well as in the sector of furniture and doors and windows in general.

Again advantageously, the proposed solution makes it possible to produce a hinge that, after proper connection of one or more specific parts of said hinge to a motor, can automatically open and close the door on which it is installed.

The aims and advantages described above will be highlighted in greater detail in the description of some preferred embodiments of the invention, provided indicatively as examples without limitation, with reference to the enclosed drawings, wherein:

FIG. 1 shows a perspective view of an example of embodiment of the articulation means carried out according to the invention;

FIGS. from 2 to 4 represent each a plan view of the element shown in FIG. 1 in a corresponding number of positions that can be assumed by the latter;

FIG. 5 shows a schematic plan view of the articulation means shown in FIG. 1;

FIG. 6 shows a schematic plan view of the articulation means shown in FIG. 1, in the various positions that can be assumed;

FIG. 7 shows an axonometric view of a further example of an articulation means carried out according to the invention;

FIGS. 8 and 9 show each a plan view of the articulation means shown in FIG. 7, in a corresponding number of positions that can be assumed;

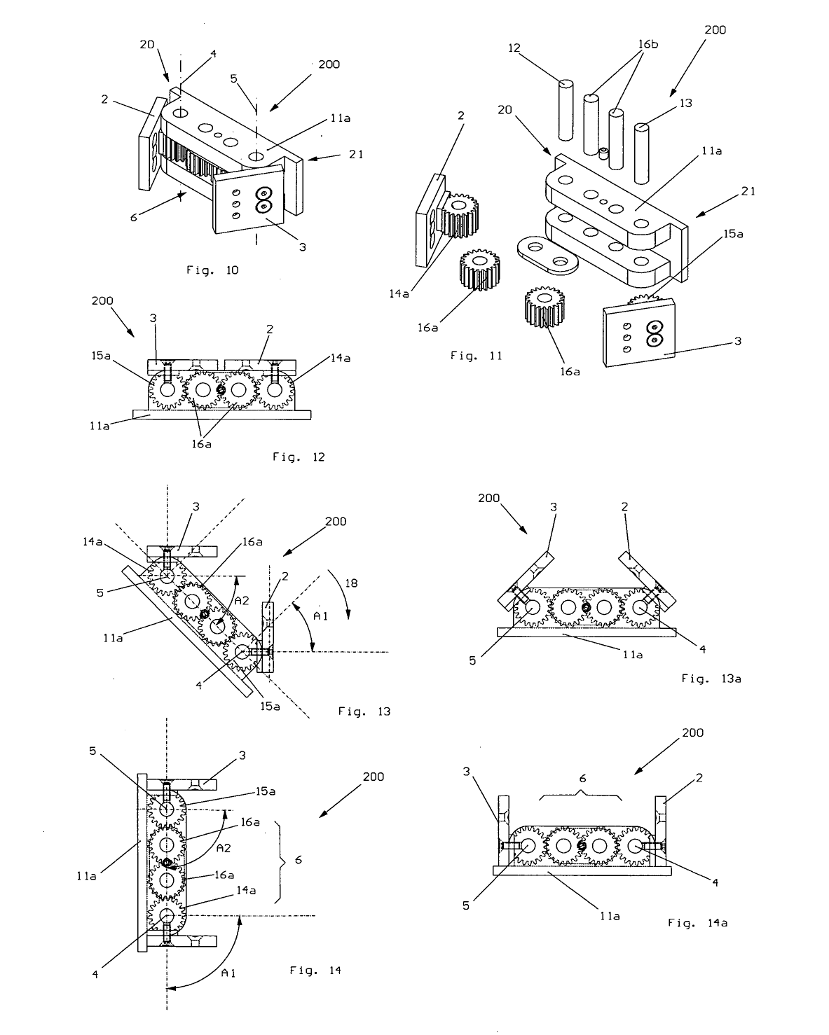

FIG. 10 shows a perspective view of another example of embodiment of the articulation means carried out according to the invention;

FIG. 11 shows an exploded perspective view of the means shown in FIG. 10;

FIGS. from 12 to 14 and from 13a to 14a show each a plan view of the means shown in FIG. 10, in a corresponding number of operating positions that can be assumed;

FIG. 15 shows a perspective view of the means shown in FIG. 10 installed to connect a door to a wall;

FIGS. from 16 to 18 show each a cross section of the articulation means, of the wall and of the door shown in FIG. 15, in a corresponding number of operating positions they can assume;

FIG. 18a shows a perspective view of the door of FIG. 15 in open position;

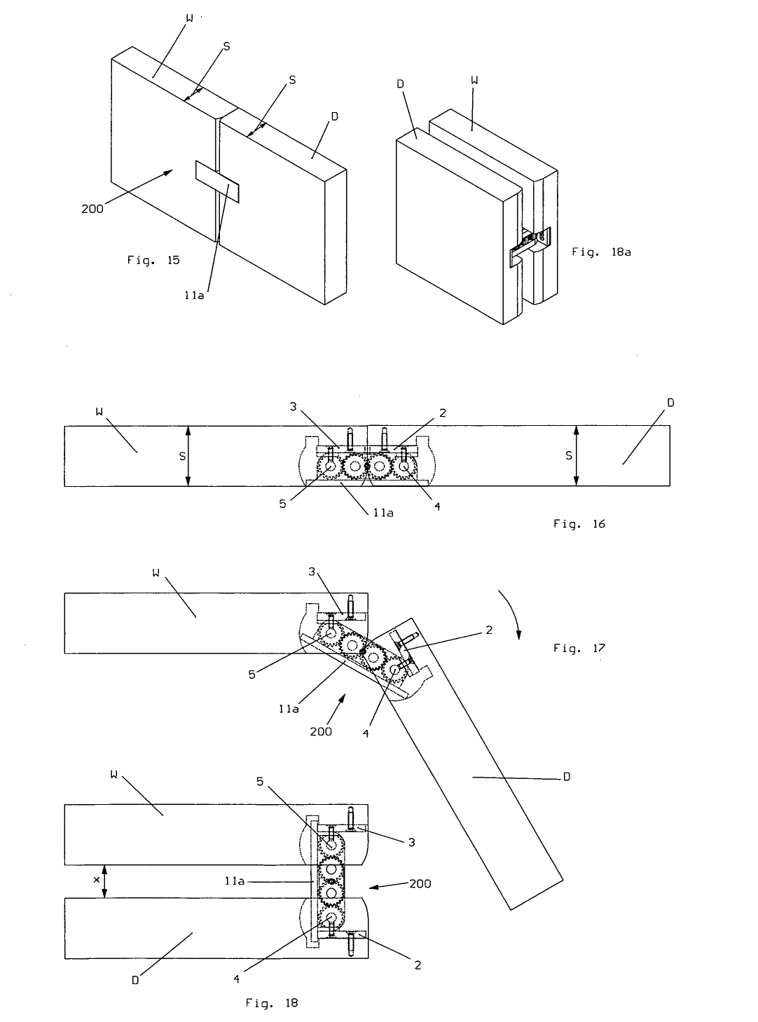

FIG. 19 shows a perspective view of another example of embodiment of the articulation means carried out according to the invention;

FIGS. from 20 to 22 show each a plan view of the means shown in FIG. 19, in a corresponding number of operating positions they can assume;

FIG. 23 shows a schematic plan view of the articulation means shown in FIG. 19;

FIG. 24 shows a schematic view of the articulation means shown in FIG. 19, in the various operating positions they can assume;

FIG. 25 shows a schematic view of another construction variant of the articulation means carried out according to the invention;

FIG. 26 shows a schematic plan view of the articulation means shown in FIG. 25, in the various positions they can assume;

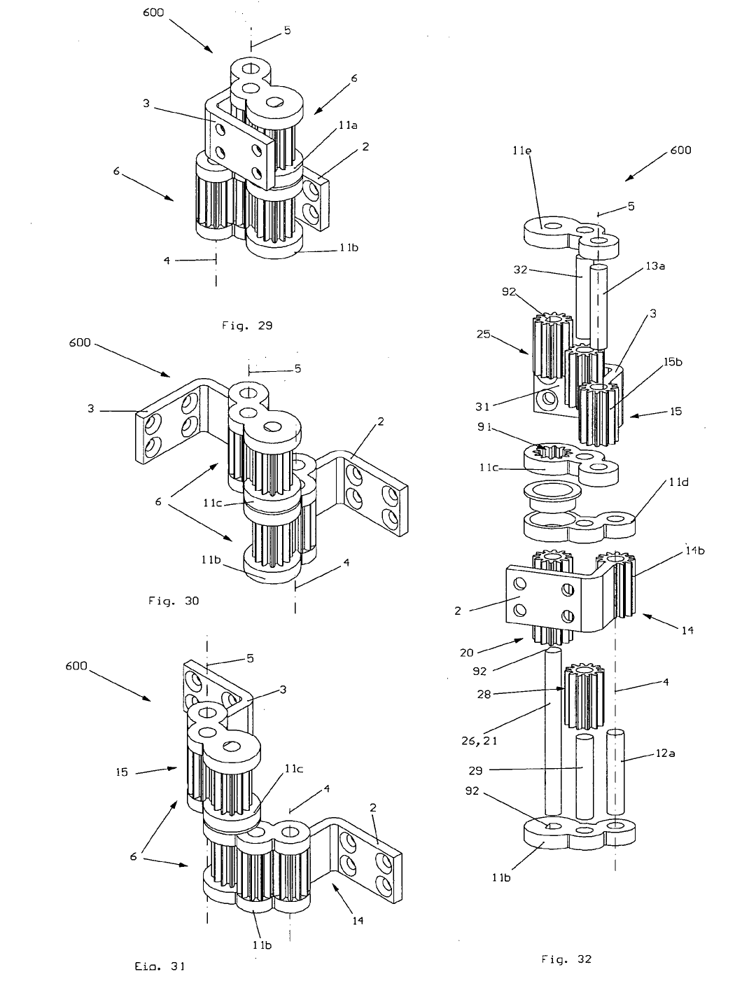

FIG. 27 shows a schematic view of another construction variant of the articulation means carried out according to the invention;

FIG. 28 shows a schematic plan view of the articulation means shown in FIG. 27, in the various positions they can assume;

FIG. 29 shows a perspective view of another construction variant of the articulation means carried out according to the invention;

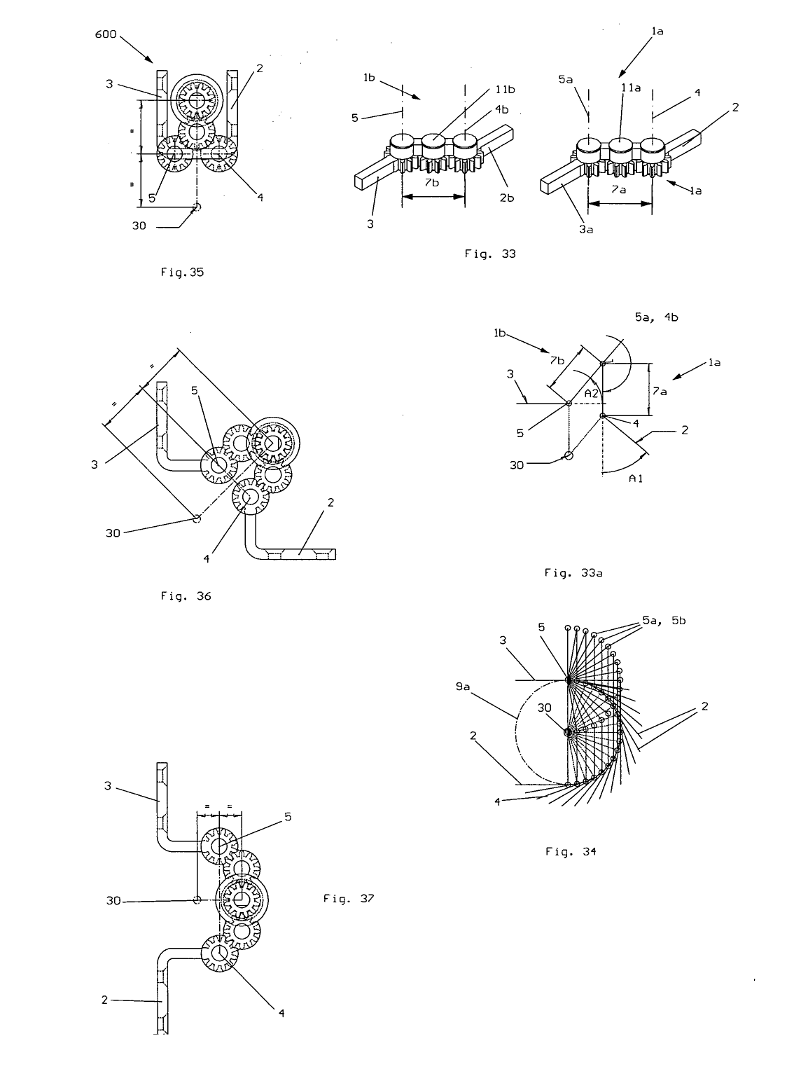

FIGS. 30 and 31 show each a perspective view of two positions that can be assumed by the articulation means shown in FIG. 29;

FIG. 32 shows an exploded perspective view of the articulation means shown in FIG. 29;

FIG. 33 shows a schematic perspective view of the articulation means shown in FIG. 29;

FIG. 33a shows a schematic plan view of the articulation means shown in FIG. 29;

FIG. 34 shows a schematic plan view of the various positions that can be assumed by the articulation means shown in FIG. 29;

FIGS. from 35 to 37 show each a plan view of the articulation means shown in FIG. 29, in a corresponding number of operating positions that can be assumed;

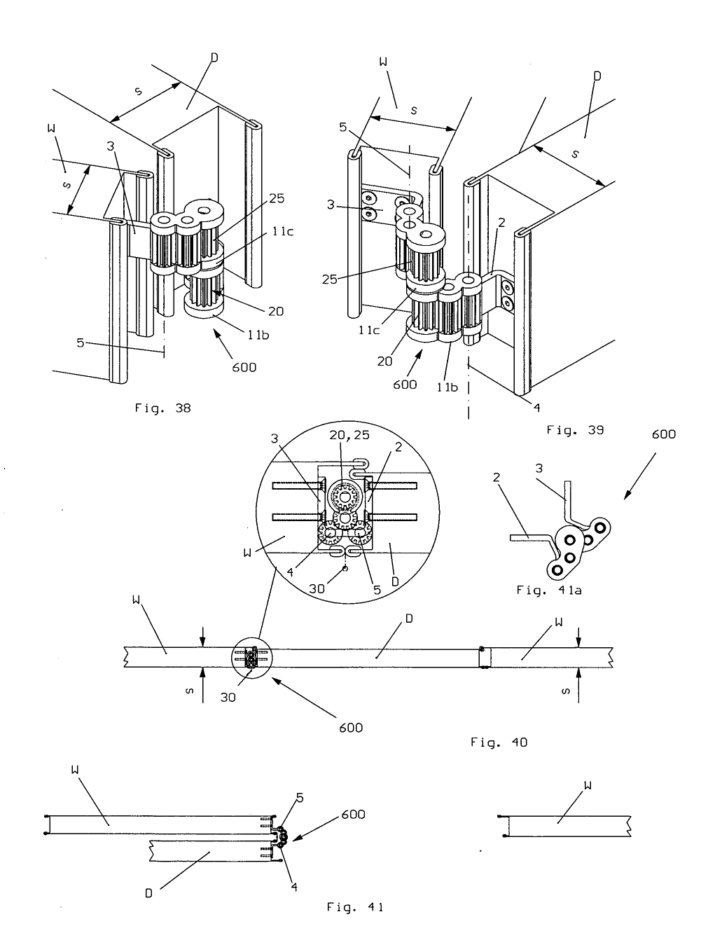

FIGS. 38 and 39 show each a perspective view of the articulation means shown in FIG. 29, applied to connect a door to a wall;

FIG. 40 shows a cross section of the articulation means, of the wall and of the door of FIG. 38 in closed position;

FIG. 41 shows a cross section of the articulation means, of the wall and of the door of FIG. 38 in open position;

FIG. 41a shows a plan view of the articulation means of FIG. 29 in one of the positions they can assume;

FIG. 42 shows a schematic plan view of a further construction variant of the articulation means carried out according to the invention;

FIG. 43 shows a schematic plan view of the articulation means shown in FIG. 42, in the various positions they can assume;

FIG. 44 shows a schematic plan view of a further construction variant of the articulation means carried out according to the invention;

FIG. 45 shows a schematic plan view of the articulation means shown in FIG. 44, in the various positions they can assume;

FIG. 46 shows a schematic plan view of a further construction variant of the articulation means carried out according to the invention;

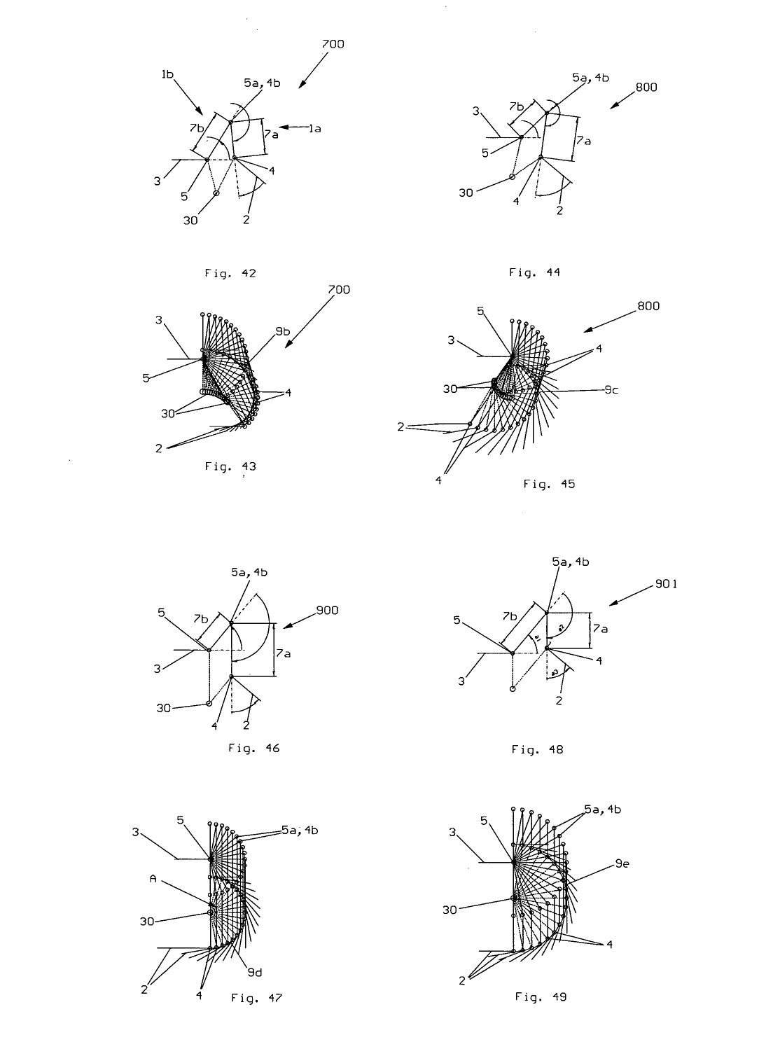

FIG. 47 shows a schematic plan view of the articulation means shown in FIG. 46, in the various positions they can assume;

FIG. 48 shows a schematic plan view of another example of embodiment of the articulation means carried out according to the invention;

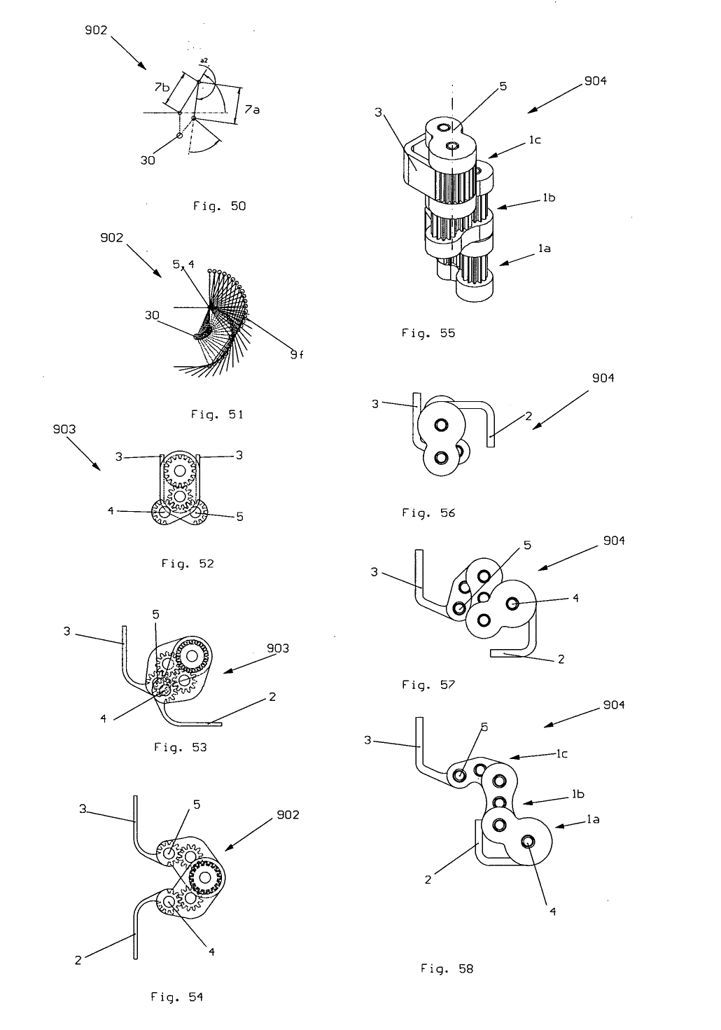

FIG. 49 shows a schematic plan view of the articulation means shown in FIG. 48, in the various positions they can assume;

FIG. 50 shows a schematic plan view of a further construction variant of the articulation means carried out according to the invention;

FIG. 51 shows a schematic plan view of the articulation means shown in FIG. 50, in the various positions they can assume;

FIGS. from 52 to 54 show each a plan view of a further example of embodiment of the articulation means of the invention in the same number of operating positions;

FIG. 55 shows a perspective view of another example of embodiment of the articulation means carried out according to the invention;

FIGS. from 56 to 58 show plan views of a corresponding number of positions that can be assumed by the articulation means shown in FIG. 55;

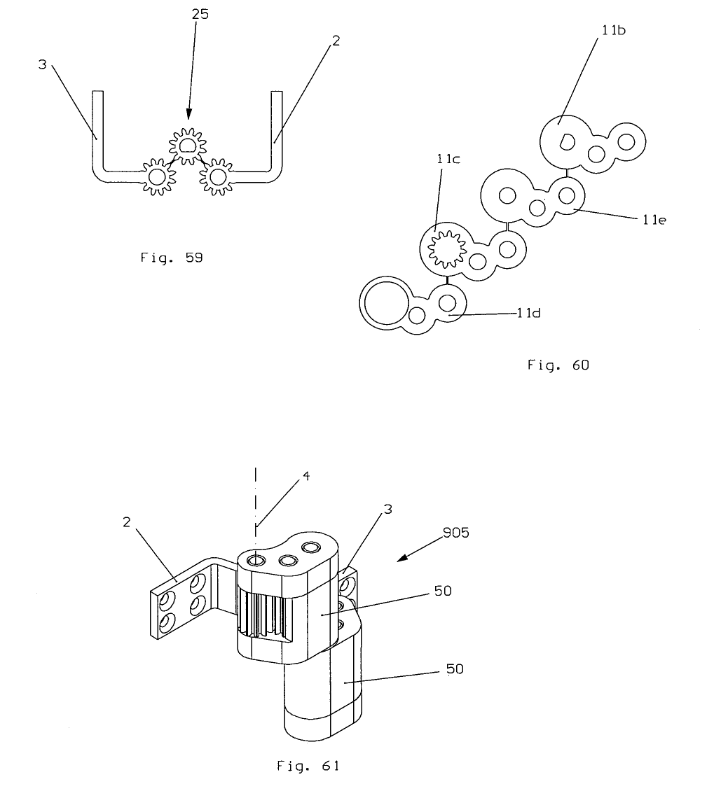

FIGS. 59 and 60 show each a cross section of an extruded profile from which it is possible to obtain some elements of the articulation means of the invention;

FIG. 61 shows a perspective view of a further example of embodiment of the articulation means of the invention;

FIG. 62 shows a perspective view of another example of embodiment of the articulation means of the invention applied to a door and to a wall;

FIG. 63 shows a front view of the articulation means of the wall and door shown in FIG. 62;

FIG. 64 shows a plan view of the door, the wall and the articulation means of FIG. 62, in open position;

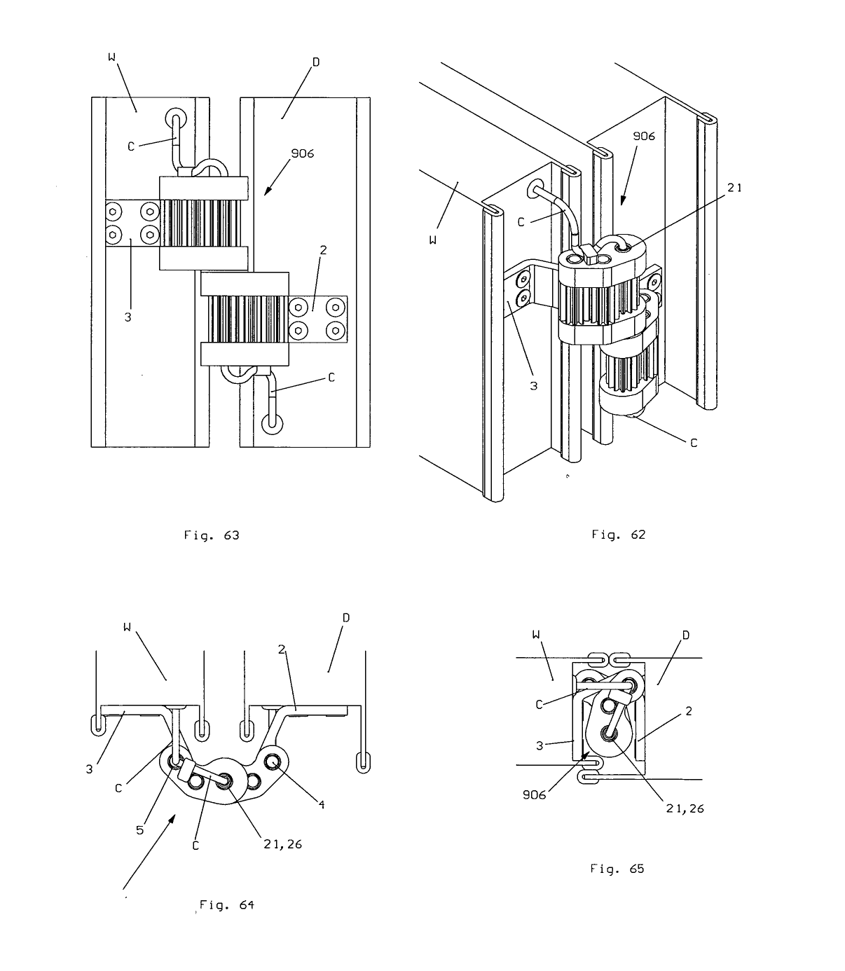

FIG. 65 shows a plan view of the door, the wall and the articulation means of FIG. 62 in closed position;

FIGS. 66 and 67 show each a perspective view of a further embodiment of the articulation means of the invention in two positions they can assume;

FIGS. 68 and 69 show each a perspective view of a further embodiment of the articulation means of the invention in two positions they can assume;

FIG. 69a shows an exploded perspective view of the articulation means shown in FIG. 68;

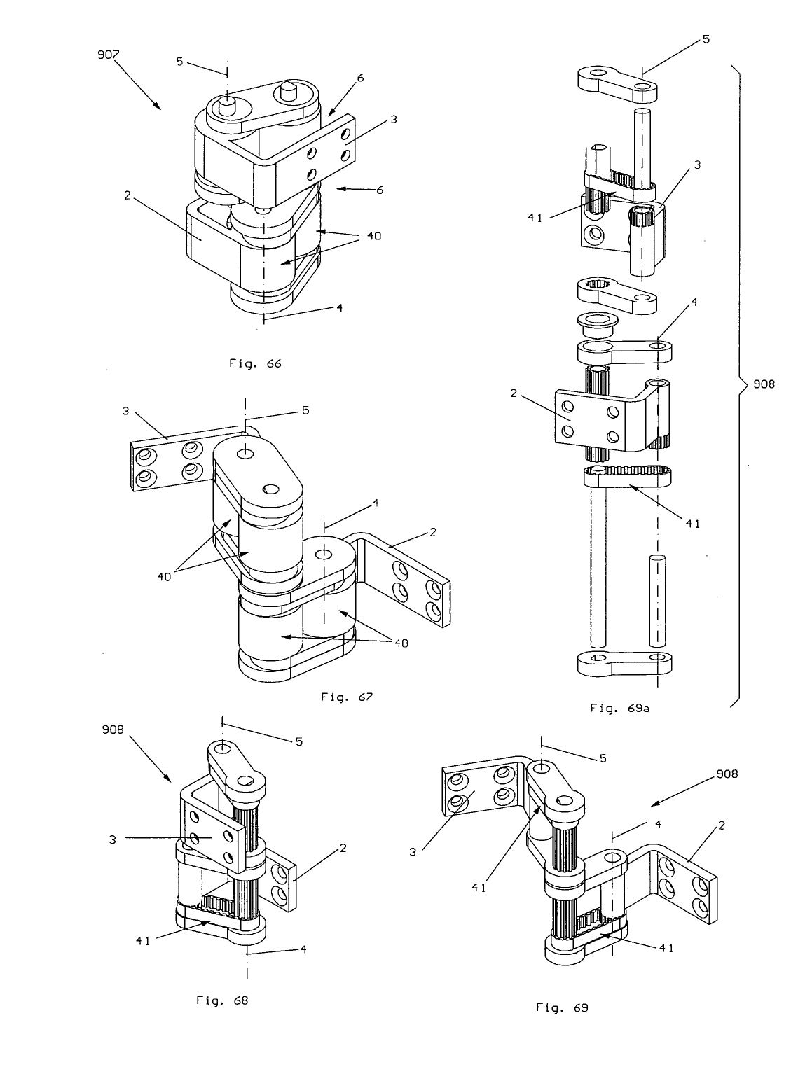

FIGS. 70 and 71 show each a perspective view of a further embodiment of the articulation means of the invention, in two positions they can assume;

FIGS. 72 and 73 show each a plan view of a further embodiment of the articulation means of the invention, in two positions they can assume;

FIG. 74 shows a perspective view of the articulation means shown in FIG. 72;

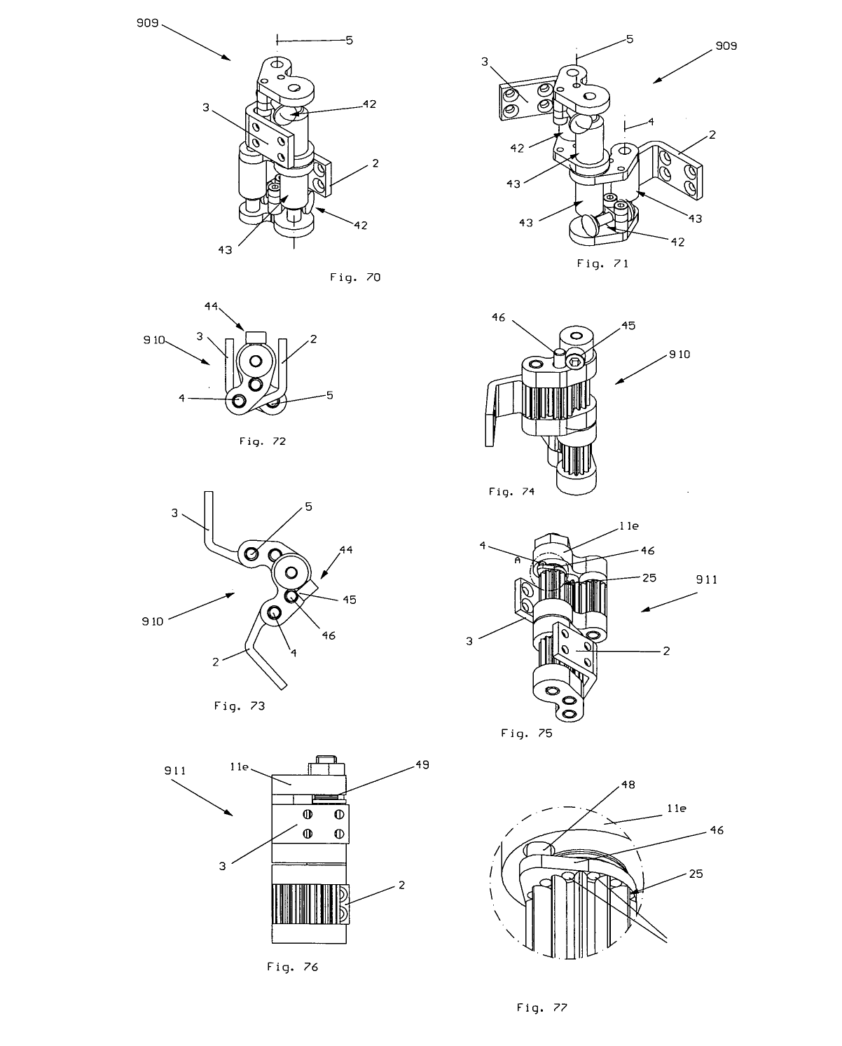

FIG. 75 shows a perspective view of a further example of embodiment of the articulation means carried out according to the invention;

FIG. 76 shows a side view of the articulation means shown in FIG. 75;

FIG. 77 shows an enlarged detail of some parts of the articulation means shown in FIG. 75;

FIG. 78 shows a perspective view of a further example of embodiment of the articulation means carried out according to the invention;

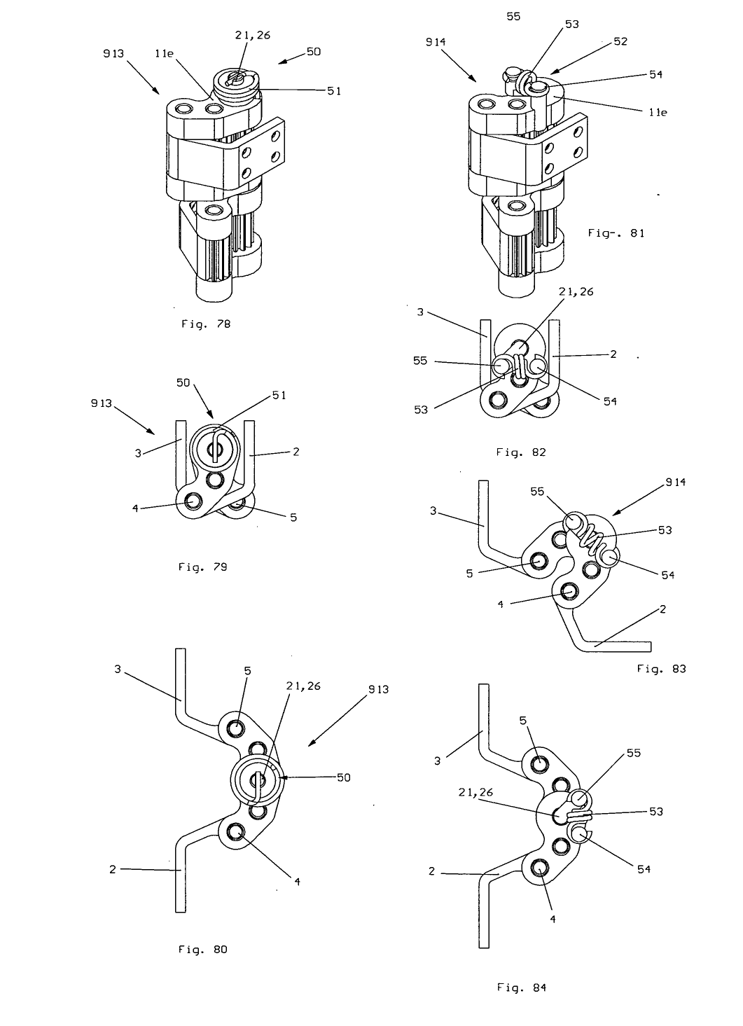

FIGS. 79 and 80 show each a plan view of the articulation means shown in FIG. 78, in a corresponding number of positions they can assume;

FIG. 81 shows a perspective view of another example of embodiment of the articulation means carried out according to the invention;

FIGS. 82, 83 and 84 show each a plan view of the articulation means shown in FIG. 81, in a corresponding number of operating positions;

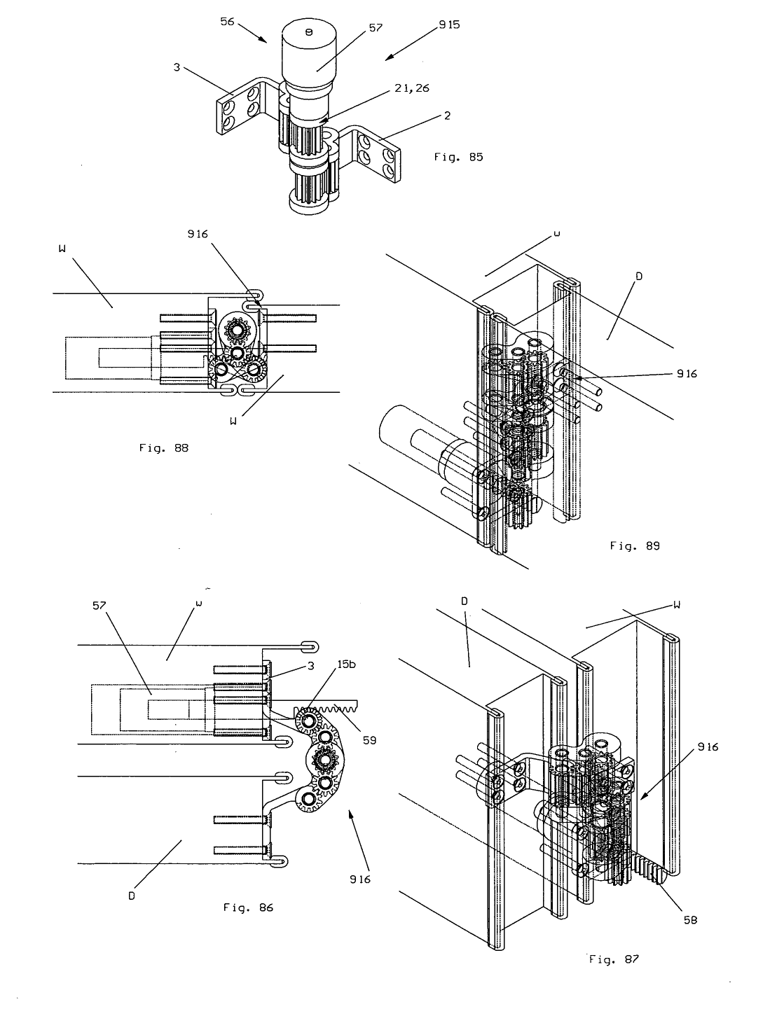

FIG. 85 shows a perspective view of a further example of embodiment of the articulation means carried out according to the invention;

FIG. 86 shows a plan view of another example of embodiment of the articulation means of the invention applied to a door and a wall, in open position;

FIG. 87 shows a perspective view of the articulation means of FIG. 86 applied to the same door and the same wall, in open position;

FIG. 88 shows a plan view of the articulation means of FIG. 86 applied to the same door and the same wall, in closed position;

FIG. 89 shows a perspective view of the articulation means of FIG. 86 applied to the same door and the same wall, in closed position.

By way of introduction, it is important to point out that corresponding components in different examples of embodiment are indicated by the same reference numbers.

In the case of a change in the position of the parts that make up the invention, the position indications given in the individual executive examples must be transferred, according to logic, to the new position.

While the following description, made with reference to the above mentioned figures, illustrates some particular embodiments of the present invention, it is clear that the invention is not limited to said particular embodiments, rather, the individual embodiments described here below clarify different aspects of the present invention, the scope and purpose of which are defined in the claims.

A non-limiting example of embodiment of the articulation means suited to connect two elements and constituting the subject of the present invention is shown in FIGS. from 1 to 4, where said means are indicated as a whole by 1.

Said articulation means comprise a first part 2 and a second part 3, each one suited to be fixed to one of said elements to be articulated, constituted for example, as will be described and illustrated in greater detail below, by a door D and a wall W.

The articulation means 1 furthermore comprise at least one first rotation axis 4 and a second rotation axis 5 preferably parallel to each other.

According to the invention, the articulation means 1 also comprise kinematic means 6 suited to ensure that a rotation of the first part 2 in relation to the first axis 4 describing a first angle A1 determines, as shown in FIG. 3, a movement of the first axis 4 in relation to the second axis 5.

In particular, the first axis 4 moves in relation to the second axis 5 on a plane that is preferably orthogonal to the axis 5 itself, describing a substantially curved trajectory.

More precisely, in the non-limiting example of embodiment illustrated herein, the kinematic means 6 are suited to maintain the same distance, indicated by 7 in FIG. 1, between the first axis 4 and the second axis 5.

More precisely, if the second part 3 is maintained fixed in its position, the first axis 4 moves on a plane with respect to the second axis 5, describing a trajectory substantially equal to an arc of a circumference 9, as schematically shown in FIGS. 5 and 6, in which the parts 2, 3 and 6 of the hinge 1 are represented with segments.

In particular, the centre of said arc of a circle 9 substantially coincides with the second axis 5. In this case, therefore, the centre of the circle, also called relative rotation centre of the hinge, belongs to the hinge itself.

It should furthermore be observed that the radius of the arc of a circle 9, as previously explained, is substantially equal to the distance 7 between the two axes 4 and 5.

In other words, the radius of the circle 9 is as long as the segment that joins the two axes 4 and 5.

Always according to the invention, the arc of a circle 9 described by the first axis 4 extends over a second angle A2 that is proportional to the first angle A1, as shown in FIGS. 3 and 5.

More particularly, considering as first angle A1 the angle defined by the straight line 10 joining the two axes 4 and 5 and a longitudinal axis 8 of the first element 2, the result is that the angle A2, intended as the angle defined by the straight line 10 that joins the two axes 4 and 5 and the longitudinal axis 9 of the second element 3, is equal to A2=K A1, where K is a coefficient that expresses the transmission ratio of the kinematic means 6.

In other words, the angle A2 is equal to the rotation of the axis 10 with respect to the axis 5 following the rotation of the first element 2.

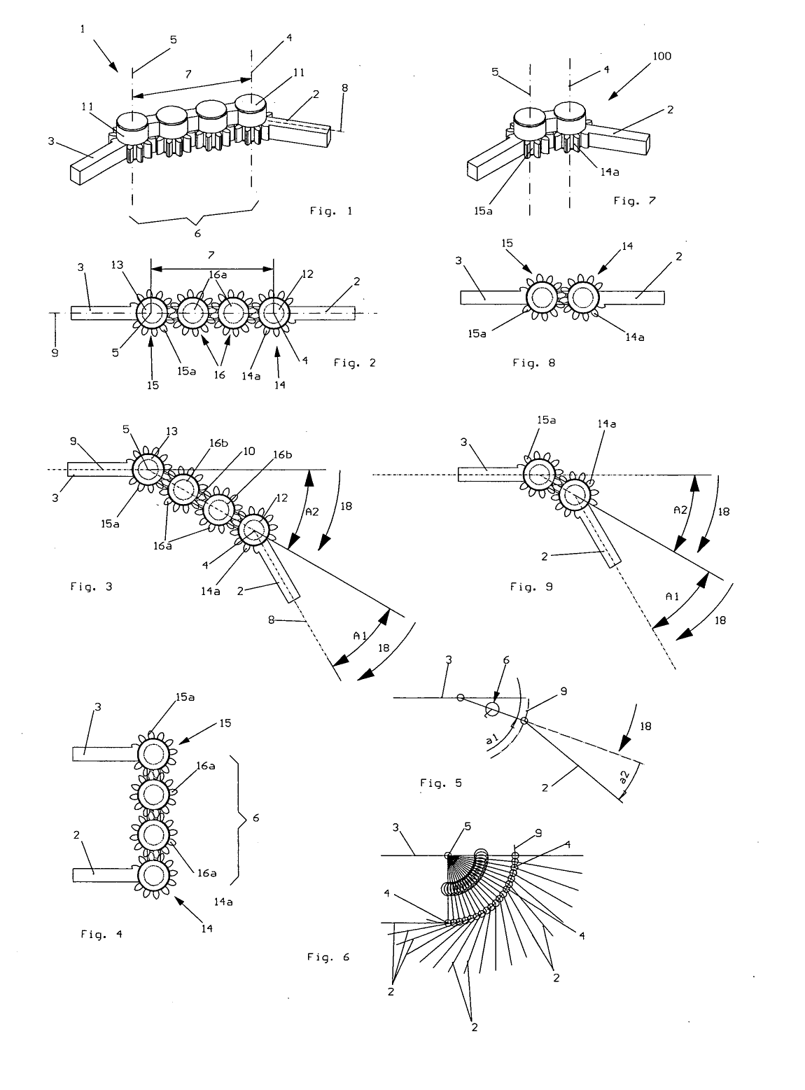

In the preferred and non-limiting embodiment of the invention represented herein, the kinematic means 6 comprise:
a first support 11 that bears a first pin 12 defining the first axis 4 and a second pin 13 defining the second axis 5, said pins being represented by broken lines in FIGS. 2, 3 and 4;
a first transmission member 14 integral with the first part 2 and rotatingly coupled with the first pin 12;
a second transmission member 15 integral with the second part 3 and rotatingly coupled with the second pin 13.

The first transmission member 14 is kinematically connected to the second transmission member 15 via auxiliary transmission means, indicated as a whole by 16.

In the preferred non-limiting embodiment of the invention represented herein, the first transmission member 14 is constituted by a first gear 14a and the second member 15 is constituted by a second gear 15a.

As regards the auxiliary transmission members 16, in the non-limiting example illustrated herein they are constituted by one or more intermediate auxiliary gears 16a rotatingly coupled with corresponding shafts 16b that are fixed to the support 11 and mesh with the above mentioned gears 14a and 15a.

In the example represented herein, therefore, the coefficient K is equal to the transmission ratio of the kinematic chain created by the gears 14, 15 and 16.

More precisely, said coefficient K is equal, in absolute value, to the ratio of the diameters of the gear wheels that make up the first transmission member 14 and the second transmission member 15. In other words, K=D1/D2, where D1 is the diameter of the first gear wheel 14 and D2 is the diameter of the second gear wheel 15.

Furthermore, the coefficient K can be a number above or below zero. This depends on the characteristics of the transmission means. More particularly, K can be a positive or negative number depending on the number of intermediate gears 16.

In particular, it should be noted that if the total number of auxiliary gear wheels 16a is an even number, like in the example shown in FIG. 1, the coefficient K is a positive number. In this case, a clockwise rotation of the first part 2 with respect to the first axis 4 determines a clockwise angular movement of the first axis 4 with respect to the second axis 5, as indicated by number 18 in FIG. 3.

Vice versa, as will be better highlighted below, if the number of auxiliary gear wheels 16 is an odd number, the coefficient K is negative and thus a rotation of the first part 2 around the first axis 4 determines a counterclockwise rotation of the first axis 4 with respect to the axis 5, which results in a movement that will be better described below.

It should be noted, in particular, that in the non-limiting example indicated in FIGS. from 1 to 4 the diameters D1 and D2 of the two gear wheels 14 and 15 are the same and the number of auxiliary gear wheels is two. In this case, therefore, K=+1 and thus A2=+A1.

A further non-limiting example of embodiment of the articulation means subject of the invention is illustrated in FIGS. from 7 to 9, where said articulation means are indicated as a whole by 100. They differ from the previous ones due to the fact that the number of intermediate gear wheels is zero. In this case, therefore, the two gear wheels 14 and 15 mesh directly with each other and K is still a positive number and in the example is equal to 1.

A further non-limiting example of embodiment of the articulation means subject of the invention is illustrated in FIGS. from 10 to 14, where said articulation means are indicated as a whole by 200. They differ from the articulation means shown in FIG. 1 due to the fact that the first support 11a is substantially U-shaped in order to better support the pins with which the various gear wheels are rotatingly coupled.

These means also comprise end-of-stroke elements 20 and 21 that limit the rotation of the parts 2 and 3 around the respective axes 4 and 5. More particularly, said end-of-stroke elements 20 and 21 are constituted, in the example represented herein, by the ends of the support 11a.

FIGS. from 12 to 14 show a corresponding number of positions, analogous to those shown for the means 1, that can be assumed by the means 200.

Also in this case, therefore, the number of intermediate gear wheels is two and thus K is a positive number; in the example K=1 and therefore A2=+A1.

It should also be noted that the FIGS. from 13a to 14a show the positions that can be assumed by the means 200 when that support 11a is kept fixed and one of the two parts 2 or 3 is rotated, and in particular moving the first part 2.

More precisely, it should be observed that if the support 11a is kept fixed, the rotation of the first element 2 by a first angle A1 in relation to the first axis 4 is associated with a rotation of the second element 3 by a second angle A2 in relation to the second axis 5. Also in this embodiment the coefficient A2=K A1 and K is equal to +1.

The FIGS. from 15 to 18a show the hinge of FIG. 10 installed to connect two elements that in the example are constituted by a wall W and a door D.

As can be observed, the hinge allows the door D to rotate by 180° and to be installed in such a way as to be hidden within the thickness S of the two elements W and D.

It should furthermore be noted that the door D when open is spaced from the wall W.

This distance, indicated by X in FIG. 18, is achieved thanks to the proposed solution and can be decided during the design stage.

A further non-limiting example of embodiment of the articulation means subject of the invention is illustrated in FIGS. from 19 to 24, where said articulation means are indicated as a whole by 300. They differ from the articulation means shown in FIG. 1 due to the fact that an odd number of auxiliary gear wheels is interposed between the first gear wheel 14a and the second gear wheel 15a. This means that the rotation of the angle takes place in the opposite direction, that is, that k is a negative number equal, in absolute value, to the ratio D1/D2.

In other words, a clockwise rotation of the first part 2 in relation to the first axis 4 determines a counterclockwise movement of the first axis 4 with respect to the second axis 5.

Vice versa, a counterclockwise rotation of the first part 2 determines a clockwise rotation of the first axis 4 with respect to the second axis 5, as schematically shown in the FIGS. 21, 23 and 24.

More particularly, in the illustrated example the diameter of the gear wheels 15a and 14a is the same and therefore k=−1, meaning that A2=−A1. In the case at hand, with the selected parameters, the two elements 2 and 3 remain always parallel to each other, as can be seen in the FIGS. from 21 to 24.

A further non-limiting example of embodiment of the articulation means subject of the invention is schematically illustrated in FIGS. 25 and 26, where said articulation means are indicated as a whole by 400.

More particularly, the mentioned figures schematically illustrate the movement of the articulation means in the case where the coefficient K is equal to −0.5.

A further non-limiting example of embodiment of the articulation means subject of the invention is illustrated schematically in FIGS. 27 and 28, where said articulation means are indicated as a whole by 500.

More particularly, the mentioned figures schematically illustrate the movement of the articulation means in the case where the coefficient K is equal to −2.

A further non-limiting example of embodiment of the articulation means subject of the invention is illustrated in FIGS. from 29 to 32, where said articulation means are indicated as a whole by 600.

They differ from the articulation means shown in FIG. 1 due to the fact that the first axis 4 moves on a plane in relation to the second axis 5 describing a curved trajectory, and more particularly said curve is a circumference 9a tangential to the second axis 5, as shown in particular in the schematic views shown in FIGS. 33a and 34.

In other words, in the proposed solution the two parts 2 and 3 move rotating in relation to a relative rotation centre indicated by 30 in FIGS. 33a and 34, arranged on a fictitious relative rotation axis preferably external to the various parts that make up the articulation means 600 and parallel to the two axes 4 and 5.

In the embodiment 600 the articulation means comprise:
a first support 11b that bears a first pin 12a defining said first axis 4;
a second support 11c that bears a second pin 13a defining said second axis 5;
transmission means suited to transmit every rotation of the first part 2 on the first axis 4 to the second support 11c and every rotation of the second part 3 on the second axis 5 to the first support 11b.

More precisely, the transmission means comprise:
a first transmission member 14 integral with the first part 2 and rotatingly coupled with the first pin 12a;
a second transmission member 15 integral with the second part 3 and rotatingly coupled with the second pin 13a;
a third transmission member 20 integral with the second support 11c and rotatingly coupled with the third pin 26, said third transmission member 20 being kinematically connected to the first transmission member 14;
a fourth transmission member 25 integral with the first support 11b and rotatingly coupled with the third pin 26, said fourth transmission member 25 being kinematically connected to the second transmission member 15.

More precisely, the third transmission member 20 is kinematically connected to the first transmission member 14 via a first auxiliary transmission member 28, rotatingly coupled with a pin 29.

The fourth transmission member 25 is kinematically connected to the second transmission member 15 via the auxiliary transmission member 31 rotatingly coupled with a pin 32.

It is worth noting that, in the non-limiting example illustrated herein the transmission members 20, 25, 28 and 31 are constituted by gears comprising gear wheels.

It should be noted, in particular, that in the non-limiting example illustrated herein the third transmission member 20 is made integral with the second support 11c as its gears fit in a corresponding seat 91 created in the element 11c.

The fourth transmission member 25 is made integral with the first support 11b thanks to a flat part 92 created on the pin 26, 21 and also in the hole suited to house it, both in the member 25 and in the support 11b.

It should also be noted that in the example the means 600 also comprise a third support 11d and a fourth support 11e for the various pins. As regards the first support 11b, it is substantially V-shaped.

Analogously, the second support 11c is substantially V-shaped. Analogously, the supports 11d and 11e have substantially the same shape.

It should be noted that, as schematically shown in FIGS. 33, 33a and 34, the articulation means 600 can be considered as obtained by connecting two elements 1a and 1b of the type represented in FIG. 19, taking care to specifically constrain the parts 3a and 2b to the corresponding supports 11b and 11a.

More precisely, the elements 1a and 1b have a coefficient ka=−1=kb and the distances 7a and 7b of the respective axes 4-5a and 4b-5 are the same.

In this case the diameter of the circle is equal to the sum of the two distances 7a and 7b of the above mentioned axes 4-5a and 4b-5.

More particularly, the diameter of the circle 9a is equal to the distance between said first axis 4 and said second axis 5 when said first part 2 and said second part 3 are arranged facing each other and parallel to each other.

FIGS. from 35 to 37 show the means 600 in a corresponding number of positions that they can assume when the first part 2 is rotated around the first axis 4.

It should also be noted that said first support element 11a and said second support element 11b are arranged on parallel but spaced planes. This allows the kinematic means 6 to behave so that said first axis 4 and said second axis 5 coincide in at least one operating position. More precisely, when said axes 4, 5 coincide, said elements are arranged on parallel planes.

In other words, the first gear wheel and the second gear wheel or pulley lie on parallel and staggered planes.

This makes it possible to further reduce the overall dimensions of the articulation means, which thus can be advantageously housed, for example, within the thickness of a door.

FIGS. from 38 to 41 show the hinge 600 of FIG. 29 installed to connect two elements that in the example are constituted by a wall W and a door D.

As can be observed, the hinge allows the door D to be rotated by 180° even if the parts 2 and 3 perform a 270° movement (see in particular FIG. 41a).

Furthermore, it can be installed in such a way as to be hidden within the thickness S of the two elements W and D.

The above clearly shows that in other embodiments of the invention the two elements 1a and 1b, connected to form the articulation means of the type indicated by 600 in FIG. 29, may have different geometric characteristics.

More particularly, as shown in FIG. 42, the distances 7a and 7b between the primary and the secondary axis of each element 1a and 1b may be different from each other.

More precisely, according to a further embodiment of the articulation means of the invention, indicated as a whole by 700 in the schematic illustration of FIG. 42, they differ from the previous ones due to the fact that the distance 7a between the two axes of the first element is shorter than the distance 7b of the second element 1b.

In this case, a rotation of the first element 2 in relation to its axis 4 determines a movement of the type schematically illustrated in FIG. 43. More particularly, the trajectory described by the axis 4a around which the first element 2 is set rotating substantially reproduces a curve that resembles a section of a spiral.

It should also be noted that in this embodiment the spiral-shaped trajectory, and more particularly the first axis 4, passes beyond the second axis 5.

In other words, the second axis 5 is arranged inside the area A delimited by the above mentioned section of a spiral.

In other words, said kinematic means are also suited to maintain said first axis and said second axis at the same distance from at least one third axis.

In this case, furthermore, Ka=d A2/dA1<−1 and K2=dA3/dA2<−1.

It should be noted that in this embodiment also the fictitious rotation centre 30 moves, as shown in FIG. 43, with a curved trajectory.

A further embodiment of the articulation means of the invention, which are indicated as a whole by 800 in the schematic illustration of FIG. 44, differs from the previous one due to the fact that the distance 7a is greater than the distance 7b.

In this case, the trajectory described by the first axis 4a when the articulation means 800 are set rotating around the same axis is the one schematically shown in FIG. 45.

In this case, furthermore, −1<Ka=d A2/dA1<0 and −1<K2=dA3/dA2<−1.

Also in this case the trajectory 9c is substantially that of a section of a spiral.

It should also be observed that in this embodiment the trajectory of the axis 4 and in particular the trajectory 9c of the above mentioned spiral neither intersects nor passes beyond the second axis 5.

More particularly, the second axis 5 never intersects the area A delimited by the spiral-shaped trajectory 9c. Also in this case the fictitious rotation centre moves with a curved trajectory, as shown in FIG. 45.

A further embodiment of the articulation means of the invention, which are indicated as a whole by 900 in the schematic illustration of FIG. 46, differs from the previous one due to the fact that the distance 7a is greater than the distance 7b.

In this case, the trajectory described by the first axis 4a when the element 2 is set rotating around the same axis 4 is the one schematically shown in FIG. 45.

More particularly, in the example illustrated herein, Ka=Kb=−1 and the trajectory 9d described by the first axis 4 is a circumference, as shown in FIG. 47.

It should also be observed that in this embodiment the trajectory of the axis 4 and in particular the trajectory 9d of the circumference neither intersects nor passes beyond the second axis 5.

It should also be noted that the second axis 5 is arranged outside the area A defined by the circular trajectory 9d described by the first axis 4 while the relative rotation centre 30 is arranged inside the area A circumscribed by the circumference 9d.

A further embodiment of the articulation means of the invention, which are indicated as a whole by 901 in the schematic illustration of FIG. 48, differs from the previous one due to the fact that the distance 7a is shorter than the distance 7b.

In this case, the trajectory 9e described by the first axis 4a when the element 2 is set rotating around the same axis 4 is the one schematically shown in FIG. 49.

More particularly, in the example illustrated herein, Ka=Kb=−1 and the trajectory 9e described by the first axis 4 is a circumference, as shown in FIG. 49.

It should also be observed that in this embodiment the trajectory of the axis 4 and in particular the trajectory 9e of the circumference passes beyond the second axis 5.

It should also be noted that the second axis 5 is arranged inside the area A defined by the circular trajectory 9e described by the first axis 4, exactly as the relative rotation centre 30 is arranged inside the area A circumscribed by the circumference 9d.

A further embodiment of the articulation means of the invention, which are indicated as a whole by 902 in the schematic illustration of FIG. 50, differs from the previous one due to the fact that the distance 7a is equal to the distance 7b.

In this case, the trajectory 9f described by the first axis 4 when the element 2 is set rotating around the same axis 4 is the one schematically shown in FIG. 51.

More particularly, in the example illustrated herein, Ka is less than 4/3 and Kb is less than 3/4 and the trajectory 9f described by the first axis 4 can be compared to a section of a spiral.

They differ from the previous ones also due to the fact that said first axis moves in relation to said second axis on a plane with a substantially rotary-translating motion.

It should also be observed that in this embodiment the trajectory of the axis 4 and in particular the trajectory 9f of the circumference intersects and may even pass beyond the second axis 5.

It should also be noted that the second axis 5 is arranged along the trajectory 9f described by the first axis 4 and the relative rotation centre 30 is arranged inside the area A circumscribed by the circumference 9f.

It should be noted that in this embodiment also the relative rotation centre 30 moves and describes a trajectory that can be seen in FIG. 51.

FIGS. from 52 to 54 show another example of embodiment of the articulation means of the type shown in FIG. 29, in a corresponding number of operating positions they can assume. More particularly, in this embodiment the articulation means, indicated as a whole by number 903, have the following characteristics: Ka=−4/3, Kb=−3/4, the distances 7a and 7b being the same.

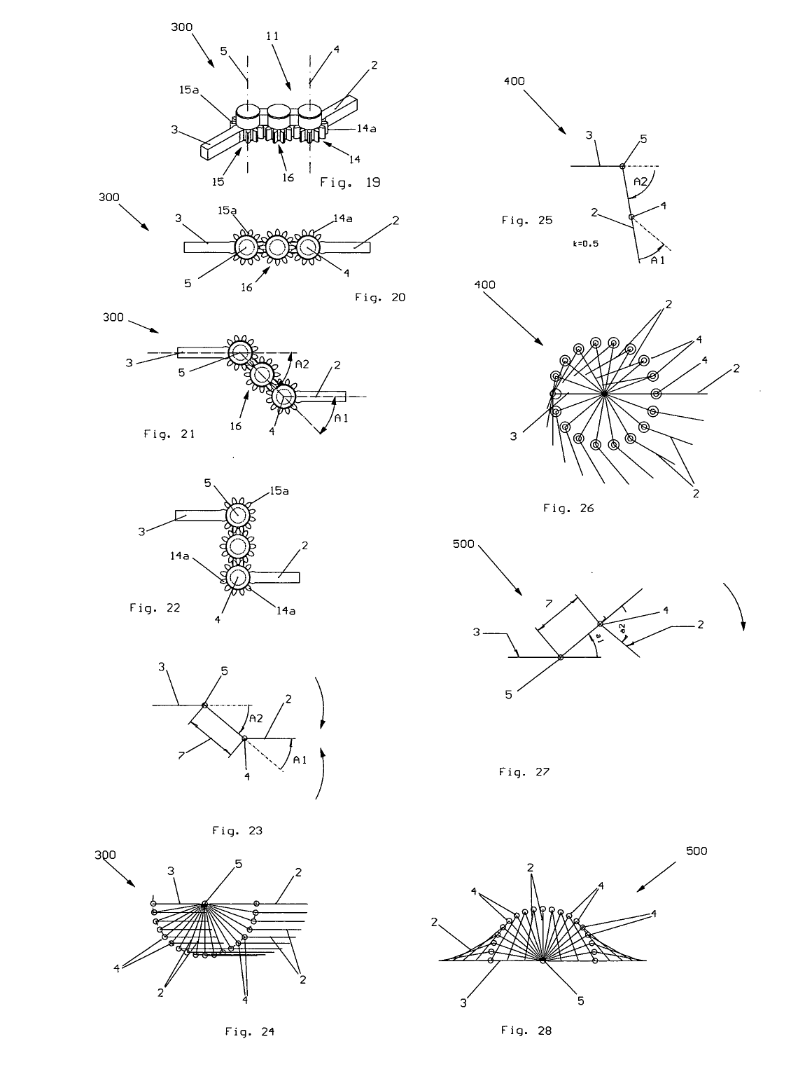

FIGS. from 55 to 58 show another example of embodiment of the articulation means. Said means, indicated as a whole by 904, differ from the previous ones due to the fact that they consist of the combination of three elements 1a, 1b and 1c of the type shown in FIG. 20, and connect the supports, the parts 3 and the gears to one another in a manner similar to that shown in the example of FIG. 29.

More generally, other embodiments of the invention may include any number of elements of the type shown in FIG. 20, connected to one another as previously described, with parameters related to the distances of the corresponding axes 4 and 5 and of the distances that can be varied according to the need. This makes it possible to obtain curved trajectories having various shapes, some specific embodiments of which are exemplified in the non exhaustive examples shown above.

FIG. 59 shows a cross section of an extruded profile in which it is possible to obtain the parts 2, 3, 25 of the articulation means shown in FIG. 32.

FIG. 60 shows a further example of an extruded profile from which it is possible to obtain the elements 11b, 11c, 11d and 11e of the articulation means shown in FIG. 32.

A further example of the articulation means of the invention is represented in FIG. 61, where they are indicated as a whole by 905.

It differs from the embodiment of FIG. 32 due to the fact that the gears 20, 25, 28 and 31 are covered by walls 50 that prevent access to the same, thus avoiding any risk for the users.

FIGS. from 62 to 65 show a further construction variant of the articulation means of the invention applied to a wall W and to a door D. More particularly the articulation means, indicated as a whole by 906, differ from the articulation means shown in FIG. 32 due to the fact that the pins 21, 26 are provided with a through hole suited to ensure the passage of a wire C, for example an electric wire.

This advantageously makes it possible to make the electrical connection of pieces of equipment arranged for example on the door W.

A further embodiment of the articulation means of the invention, which are indicated as a whole by 907 in FIGS. 66 and 67, differs from the articulation means of FIG. 32 due to the fact that the kinematic means 6, and more precisely the transmission means, are constituted by connecting rods 40, and not by gear wheels.

A further embodiment of the articulation means of the invention, which are indicated as a whole by 908 in the FIGS. 68, 69 and 69a, differs from the articulation means of FIG. 32 due to the fact that the kinematic means 6, and more precisely the transmission means, are constituted by belts 41, and not by gear wheels.

More precisely, they differ from the previous ones due to the fact that said transmission means comprise at least one first pulley with diameter D1 integral with said first axis and at least one second pulley with diameter D2 integral with said second axis, said pulleys being connected via a flexible element.

The flexible element is constituted by a chain and/or a belt.

Also in this case, K=D1/D2, where D1 and D2 are respectively the diameter of the first and of the second pulley.

Also this embodiment can be provided with an even or odd number of auxiliary pulleys.

A further embodiment of the articulation means of the invention, which are indicated as a whole by 909 in FIGS. 70 and 71, differs from the articulation means of FIG. 32 due to the fact that the kinematic means 6, and more precisely the transmission means, are constituted by transmission spindles 42 that cooperate with corresponding bevel gear pairs 43.

It is also clear that all the articulation means described above may comprise mechanical end-of-stroke elements.

In particular, FIGS. 72 and 74 show a further embodiment of the articulation means of the invention indicated as a whole by 910, which differ from the articulation means shown in FIG. 29 due to the fact that they comprise also a mechanical end-of-stroke element indicated by number 44.

Said end-of-stroke element substantially comprises a first element 45 suited to counteract a second element 46 in order to limit the opening angle of the articulation means 910.

A further embodiment of the articulation means of the invention, indicated as a whole by 911 in FIGS. 75 and 76, differs from the embodiment of FIG. 29 due to the fact that it comprises a member suited to ensure a so-called snap opening.

More particularly, in said embodiment the articulation means 911 comprise a ring nut 46 shown in detail in FIG. 77, provided with a plurality of holes 47 equally spaced from one another and suited to house an element 48 pushed by a spring 49 visible in FIG. 76. The ring nut 46 is integral with the gear 25, while the element 48 is integral with the support 11e.

Operatively, the rotation of the first element 2 determines a rotation of the gear 25 and thus forces the element 48 to lift elastically until reaching the successive opening 47, thus obtaining a snap opening.

It is clear that in other embodiments of the invention the elastic element may act on the ring nut 46 and the element 48 may be fixed.

It is also clear that in other embodiments of the invention the element 48 may be integral with the gear 25 and the ring nut 46 may be integral with the support 11e.

A further embodiment of the articulation means of the invention, indicated as a whole by 913 in FIGS. from 78 to 80, differs from the embodiment of FIG. 29 due to the fact that it also comprises elastic recovery means indicated as a whole by 50.

More particularly, in the example illustrated herein the recovery means 50 comprise a torsion spring 51, having one end fixed to the support element 11 and the other end integral with the pin 21, 26.

In the example illustrated herein, the torsion spring 51 is arranged in such a way as to be loaded when the articulation means 913 are brought into the opening position shown in FIG. 80.

This means that the spring 50 in said position exerts on the pin 21, 26 such a force as to set it rotating, thus tending to move the means 913 into the rest position shown in FIG. 79.

It is also clear that the torsion spring 50 can be arranged in such a way as to be elastically loaded when the articulation means 913 are brought into the closed position shown in FIG. 79.

In this case the spring 50 naturally tends to move the articulation means 913 into the opening position shown in FIG. 80.

FIGS. from 81 to 84 show a further embodiment of the articulation means of the invention, indicated as a whole by number 914.

They differ from the previous ones due to the fact that they comprise an elastic element 52 that makes it possible to naturally bring the hinge 914 both into the closed position shown in FIGS. 81 and 82 and in the open position shown in FIG. 84.

More particularly, the elastic element 52 is constituted by a helical spring 53 having a first end integral with a first anchorage element 54 fixed to the support 11e and the second end integral with a second anchorage element 55 hinged on the pin 21, 26.

In particular, it should be noted that the anchorage elements 54 and 55 are arranged so that the spring 53 is loaded when the articulation means 914 are in the intermediate position shown in FIG. 83. In this position, therefore, the helical spring 53 exerts a recovery force that sets the pin 21, 26 rotating and thus moves the articulation means 914 towards the closed position shown in FIG. 82 or towards the open position shown in FIG. 84.

It should be noted, in particular, that said elastic recovery towards the closed position takes place as soon as a movement of the element 2 determined by the user makes the hinge pass beyond the intermediate position shown in FIG. 83 moving towards the closed position shown in FIG. 82.

Vice versa, said elastic recovery towards the open position takes place as soon as a movement of the element 2 determined by the user makes the hinge pass beyond the intermediate position shown in FIG. 83 moving towards the open position shown in FIG. 84.

A further embodiment of the articulation means of the invention, which are indicated as a whole by 915 in FIG. 85, differs from the previous one due to the fact that said articulation means are powered.

More particularly, the articulation means comprise power means indicated by 56 and suited to set the kinematic means 6 rotating.

More particularly, the articulation means 915 differ from the articulation means shown in FIG. 29 due to the fact that they comprise the above mentioned power means 56 constituted in the example by an electric motor 57 whose shaft is connected to the pin 21, 26.

In this case, the start of the electric motor 57 sets the pin 21, 26 rotating and this, via the kinematic means, opens or closes the articulation means 915.

FIGS. from 86 to 89 show a further embodiment of the articulation means of the invention, which are indicated as a whole by 916 and differ from the previous ones due to the fact that the power means 56 comprise a linear motor 58 which moves a rack 59 which in turn meshes with one of the gear wheels 15b of the same means 916.

It is clear that in other embodiments of the invention the articulation means described above may comprise several single articulation means of the type described, associated with one another in order to form different articulation means.

It is also clear that, in other embodiments not represented herein, the articulation means may employ mixed systems comprising pulleys, gear wheels, gears, chains, belts or bevel gear pairs combined with one another in order to create the kinematic chain described above.

It is also clear that all the embodiments described above may be powered.

It should furthermore be noted that according to the length of the pins and/or gears of the articulation means described above, the capacity of said means can be varied.

It should also be noted that the articulation means described herein can be advantageously used in the construction of safe boxes. In fact, as the articulation means described above can be completely housed within the thickness of the door and of the wall to which they are applied, they cannot be reached from the outside when the door is closed (see for example FIGS. 40, 65, 68). This prevents any type of tampering.

Furthermore, the means proposed herein make it possible, for example, to open a door while at the same time advantageously moving it away from the wall to which it is applied. Said distance between door and wall can furthermore be decided during the design stage, by varying the dimensional characteristics of the hinge (for example the distances 7a and 7b).

It should also be observed that the kinematic means 6 reduce to one the degree of freedom of the proposed articulation means (having at least two axes 4 and 5).

Still advantageously, this allows the articulation means of the invention to be used to make doors in concave or convex walls, which are often present, for example, in means of transport like cars or campers.

Even though the invention has been described making reference to the attached drawings, upon implementation changes can be made that shall all be considered protected by the present patent, provided that they fall within the scope of the inventive concept expressed in the following claims.

It is also important to remember that when the details mentioned in the claims below are followed by references, these must be understood as meant to improve the comprehensibility of the claim in question and not as a limit to the interpretation of the same.

It should also be underlined that all the parts can be replaced with other technically equivalent parts, that any material can be used, provided that it is compatible with the intended use, and that the various elements can have any size, depending on the needs.

1.-40. (canceled)

41. Articulation means 600 suited to connect two elements (W, D), said means comprising a first part (2) and a second part (3), each one suited to be fixed to one of the above mentioned elements (W, D) and at least one first rotation axis (4) and a second rotation axis (5), said means further comprising transmission means (6) suited to ensure that a rotation of said first part (2) by a first angle (A1) with respect to said first axis (4) determines a rotation of said first axis (4) with respect to said second axis (5); characterized in that said first axis (4) is rotated in relation to said second axis (5) describing a substantially curved trajectory belonging to a circumference (9a) tangential to said second axis (5).

42. Means (600) according to claim 41, characterized in that said two parts (2, 3) move rotating in relation to a relative rotation centre (30) arranged on a fictitious relative rotation axis, external to the various parts that make up said articulation means.

43. Means (600) according to claims 41, characterized in that they comprise:
a first support (11b) that bears a first pin (12a) defining said first axis (4);
a second support (11c) that bears a second pin (13a) defining said second axis (5);
said transmission means being suited to transmit every rotation of the first part (2) on the first axis (4) to the second support (11c) and every rotation of the second part (3) on the second axis (5) to the first support (11b).

44. Means (600) according to claim 43, characterized in that said transmission means comprise:
a first transmission member (14) integral with said first part (2) and rotatingly coupled with said first pin (12a);
a second transmission member (15) integral with said second part (3) and rotatingly coupled with said second pin (9);
a third transmission member (20) integral with said second support (11c) and rotatingly coupled with a third pin (21, 26), said third transmission member (20) being kinematically connected to said first transmission member (14);
a fourth transmission member (25) integral with said first support (11b) and rotatingly coupled with said third pin (26), said fourth transmission member (25) being kinematically connected to said second transmission member (15).

45. Means according to claim 44, characterized in that said third transmission member (20) is kinematically connected to said first transmission member (14) via a first auxiliary transmission member (28) rotatingly coupled with a pin (29).

46. Means according to claim 44, characterized in that said fourth transmission member (25) is kinematically connected to said second transmission member (15) via an auxiliary transmission member (31) rotatingly coupled with a pin (32).

47. Means according to claim 44, characterized in that at least one of said supports (11b, 11c, 11d, 11e) is substantially V-shaped.

48. Means (600) according to claim 41, characterized in that said first axis (4) and said second axis (5) coincide in at least one operating position.

49. Means according to claim 41, characterized in that said first support element (11b) and said second support element (11c) are arranged on parallel but spaced planes.

50. Means according to claim 41, characterized in that they comprise through holes suited to allow the passage of an element (C) preferably comprising an electric wire.

51. Means (911) according to claim 41, characterized in that they also comprise a member suited to allow snap movements.

52. Means (913, 914) according to claim 41, characterized in that they also comprise elastic recovery means (50, 52) suited to bring said articulation means back to a rest position.

53. Means (915, 916) according to claim 41, characterized in that they also comprise power means suited to set said transmission means (6) rotating in order to move said articulation means.

54. Articulation unit characterized in that it comprises at least two articulation means carried out according to the contents of the preceding claims, said articulation means being mechanically connected through their corresponding parts.

55. Articulation unit characterized in that said gears create a kinematic chain with a positive or negative transmission ratio.

56. Means according to claim 45, characterized in that said fourth transmission member (25) is kinematically connected to said second transmission member (15) via an auxiliary transmission member (31) rotatingly coupled with a pin (32).

57. Means according to claim 45, characterized in that at least one of said supports (11b, 11c, 11d, 11e) is substantially V-shaped.

58. Means according to claim 46, characterized in that at least one of said supports (11b, 11c, 11d, 11e) is substantially V-shaped.

59. Means (600) according to claim 42, characterized in that said first axis (4) and said second axis (5) coincide in at least one operating position.

60. Means (600) according to claim 43, characterized in that said first axis (4) and said second axis (5) coincide in at least one operating position.
